(19) United States
(12) Patent Application Publication
(10) Pub. No.: US 2005/0205575 A1
(43) Pub. Date: Sep. 22, 2005

(54) Container sealing structure, container with the sealing structure, and method of manufacturing the sealing structure

(75) Inventors: Tomomi Kobayashi, Yokohama-shi (JP); Kenichi Takao, Yokohama-shi (JP); Kouji Nagata, Yokohama-shi (JP); Wataru Kurokawa, Yokohama-shi (JP); Kazuhiko Tsukada, Yokohama-shi (JP)

Correspondence Address: DARBY & DARBY P.C., P. O. BOX 5257, NEW YORK, NY, 10150-5257, US

(73) Assignee: Toyo Seikan Kasha , Ltd., Tokyo (JP)

(21) Appl. No.: 10/498,580

(22) PCT Filed: Dec. 25, 2002
(86) PCT No.: PCT/JP02/13537

§ 371 Date: Jun. 9, 2004

(30) Foreign Application Priority Data
Dec. 28, 2001 (JP) 2001-402049

(51) Int. Cl. B65D 41/04; B67B 1/06; B67B 3/20

(52) U.S. Cl. 220/288; 220/304; 215/329; 215/44; 53/490

(57) ABSTRACT

A task of the present invention is to provide a container sealing structure capable of easily and surely unsealing a container and hygienically maintaining an opening portion at the time of resealing, and a method of manufacturing the sealing structure. The container sealing structure of the present invention is configured by integrally forming a pouring portion (12) and a cap portion (16). An easily breakable portion (15) is formed in the container sealing structure. The pouring portion (12) and the cap portion (16) includes an intermediate wall (13) which is formed by bending downwardly from an upper end portion of an inner wall (11) and an outer wall (14) which is formed by bending upwardly from a lower end portion of the intermediate wall (13).

### TECHNICAL FIELD

The present invention relates to a sealing structure of a beverage container such a beverage can, a plastic bottle or the like, a petroleum can or the like, and more particularly a container sealing structure which enables easy unsealing and resealing after unsealing, a container provided with the sealing structure and a method of manufacturing the sealing structure.

### BACKGROUND ART

As a hermetically sealed container such as a juice can, a beer can, a carbonate beverage can, a coffee beverage can, a black tea beverage can or the like, a container which seams an easily openable lid to an opening end portion of a container body has been popularly used. An easily breakable portion (scores) which defines an opening portion (pouring portion) is formed in the easily openable lid, wherein by breaking and pushing the easily breakable portion downward using a pinching tab which is fixedly mounted on a lid body by riveting, an opening portion which constitutes an outlet for drinking is formed. With respect to such a conventional hermetically sealed container, when some beverage remains in the container after drinking, it is unable to reseal the opening portion and hence, there have been drawbacks that it requires time and efforts to throw away the remaining beverage or to move the beverage in the container to a cup or the like and to preserve the beverage in a refrigerator and, at the same time, a foreign substance adheres to the lid thus easily giving rise to an unhygienic situation. Accordingly, to enable resealing of the opening portion, for example, a following technique has been proposed.

Japanese Unexamined Patent Publication 2000-296866 describes a container provided with a resealing cap. In this resealing container, a resin-made cap which is replaceably capped on an opening portion of a can container lid includes an annular flange portion having a portion which is brought into close contact with an upper end surface of the opening portion, a first cylindrical portion which extends downwardly from the flange portion and forms an engaging portion with the opening portion on an inner surface thereof, a second cylindrical portion which extends upwardly from the flange portion, a pushbutton portion having a cylindrical pedestal shape which is concentrically arranged at an inner side than the second cylindrical portion with a distance therebetween, a plug portion which extends outwardly and upwardly from the vicinity of a lower end of the pushbutton portion, and a movable connecting portion which is formed of a thin annular conical plate which connects an upper end of the plug portion and an inner peripheral surface of the second cylindrical portion by integral molding. Here, the cap is mounted and removed by the engagement between the opening portion of the can lid and the first cylindrical portion of the cap. At the same time, the pushbutton portion and the plug portion are displaced downwardly by causing the elastic deformation of the movable connecting portion by pushing the pushbutton portion of the cap with a finger from above. As a result, with respect to a metal-made container which has a substantially annular breakable fragile portion (scores) except for one portion which constitutes a hinge portion, the fragile portion is broken and a portion surrounded by the fragile portion is pushed downwardly into the inside of the can body and hence, a pouring mouth is opened. Further, in resealing the opening portion, the movable connecting portion is made to get over a dead point and to turn downwardly so that the flange portion of the cap is brought into close contact with an upper end surface of the opening portion of the can lid thus enabling sealing of the opening portion.

However, the conventional technique which is disclosed in Japanese Unexamined Patent Publication 2000-296866 has following tasks to be solved.

(1) There exists a drawback that since the resin made cap is constituted separately from the container body, steps for manufacturing the container become cumbersome thus worsening the productivity.

(2) There exist drawbacks that due to vibrations and impacts the container receives during the transportation before use or the like, there is a possibility that the cap is removed from the container body and, at the same time, the cap exhibits poor durability during use thereof.

(3) There exist drawbacks that since the easily breakable portion is opened by pushing the cap from above with the finger, an infant or an aged person or the like who lacks the strength and shows an unsteady hand motion cannot easily open the easily breakable portion and, at the same time, since a user cannot confirm an opened state until the user removes the cap, the container lacks the reliability of opening.

(4) There exists a drawback that, at the time of resealing, foreign substances such as dust or debris stay or are adhered to a joint portion between the cap and the opening portion and hence, the container becomes unhygienic.

(5) There exists a drawback that since the container body and the cap are made of different materials from each other, at the time of throwing away the container body and the cap, it is necessary to classify them whereby handling of these parts becomes inconvenient and exhibits poor recycling performance.

The present invention has been made to solve the above-mentioned drawbacks and it is an object of the present invention to provide a container sealing structure which exhibits the excellent productivity at the time of manufacturing containers and the excellent durability during the transportation or the like and, at the same time, a container provided with the container sealing structure which can allow even an infant, an aged person or the like to easily and surely open the container and can hygienically maintain an opening portion at the time of resealing.

### DISCLOSURE OF THE INVENTION

A container sealing structure described in claim 1 is configured such that a pouring portion and a cap portion are continuously and integrally formed and an easily breakable portion is provided.

Since the pouring portion and the cap portion are continuously and integrally formed with each other, the sealing property at the cap portion after filling the contents is perfectly assured and, at the same time, it is possible to provide the container sealing structure which can exhibit the excellent productivity in manufacturing the containers and the excellent durability during transportation. Still further, since the pouring portion and the cap portion are formed of a single material, at the time of throwing away the container, it is unnecessary to separate the container into a container body and the cap portion thus exhibiting the excellent recycling property and the throw-away availability. Still further, since the container sealing structure is provided with the easily breakable portion, even an infant, an aged person or the like can manipulate the easily breakable portion formed in a thin groove shape or a slit shape which is arranged at the outside of the container and can surely open the container while observing the broken state. Further, the container sealing structure exhibits the excellent tamper evident property. Still further, at the time of resealing, the cap portion can be easily mounted on the pouring portion and hence, the opening portion can be hygienically maintained.

The container sealing structure described in claim 2 is constituted such that the pouring portion and the cap portion are constituted of an intermediate wall which is folded back downwardly from an upper end portion of an inner wall and an outer wall which is folded back upwardly from a lower end portion of the intermediate wall.

Due to such a constitution, an upper end of the pouring portion which is exposed by unsealing the container has a curvature at a fold-back portion between the inner wall and the intermediate wall and hence, the contents can be smoothly poured from pouring opening and, at the same time, even when a user drinks a beverage while bringing his mouth into direct contact with the pouring portion (a so-called “trumpet drinking”), there exist no fears including a fear that his mouth is injured and hence, the container sealing structure can also exhibit the excellent safety.

The container sealing structure described in claim 3 is configured such that the container sealing structure includes engaging portions.

Due to such a constitution, the inner wall and the intermediate wall are replaceably engaged with each other or the intermediate wall and the outer wall are replaceably engaged with each other and hence, it is possible to hygienically preserve a beverage which remains in the inside of the container after opening the container from which the easily breakable portion is separated.

The container sealing structure described in claim 4 is configured such that the engaging portions are formed of threads. Due to such a constitution, any pair of the inner wall, the intermediate wall and the outer wall is in the thread engagement with each other and hence, the cap is replaceably mounted on the container body whereby the resealing function after opening the container can be ensured. Further, the resealing can be performed by merely screwing the cap portion and no special tool is necessary thus exhibiting the excellent handling property.

The container sealing structure described in claim 5 is configured such that in a midst portion of a contiguous path which connects threads formed on the cap portion and threads which are engaged with the threads formed on the cap, a panel portion which becomes resilient by a torsional force is formed.

The panel which becomes resilient due to the torsional force is referred to as “a torsional resilient panel” hereinafter. Due to the above-mentioned constitution, when the cap portion is twisted, upper and lower portions of the torsional resilient panel are deformed in a compressed manner thus giving rise to a thread thrust by a torsional torque. A tensile strength is added to a shearing force generated by the thread thrust thus bringing about a manner of operation and an advantageous effect that the easily breakable portion can be easily broken.

The container sealing structure described in claim 6 is configured such that the engaging portions are formed of the undercut structure. By adopting the undercut engagement, the cap can be easily mounted on and removed from the container body with one touch manipulation and hence, even an infant or an aged person can easily handle the container sealing structure.

The container sealing structure described in claim 7 is configured such that the easily breakable portion is formed on a boundary between the pouring portion and the cap portion.

Due to such a constitution, by breaking the easily breakable portion thus separating the cap portion from the container body, it is possible to pour out the contents from the container and, at the same time, the separated cap portion can be utilized again for the purpose of resealing.

The container sealing structure described in claim 8 is configured such that the easily breakable portion is formed of scores. Due to such a constitution, it is possible to surely and easily form the easily breakable portion.

The container sealing structure described in claim 9 is configured such that the easily breakable portion is formed of slits. Due to such a constitution, the unsealing property can be enhanced. Here, in this case, to ensure the sealing property, it is desirable to use a sealing material as described in claim 10.

The container sealing structure described in claim 10 is configured such that a sealing material is interposed between an inner surface of the cap portion and the pouring portion. Due to such a constitution, the sealing property at the time of resealing can be enhanced. The constitution is particularly effective in the engagement adopting the undercut structure.

The container sealing structure described in claim 11 is configured such that the sealing structure is formed of a metal material. By adopting the metal material which exhibits the excellent formability, the fold-back operation for forming the triplicate wall consisting of the inner wall, the intermediate wall and the outer wall is facilitated whereby it is possible to provide the container sealing structure which exhibits the excellent durability and the excellent anti-leaking property.

The container sealing structure described in claim 12 is configured such that the container sealing structure is formed of a plastic material. Due to such a constitution, it is possible to apply a molding method such as injection molding, extrusion molding or the like thus enabling the reduction of a manufacturing cost at the time of manufacturing the container sealing structures on a mass production basis.

A container described in claim 13 is a container provided with the container sealing structure of any one of claims 1 to 12 and is configured such that the container sealing structure is connected to an opening portion formed on an upper portion of a container body. Further, the container is configured such that the container sealing structure is integrally formed with the container body and a bottom lid portion is connected to a lower portion of the container body. Due to such a constitution, filling and sealing of the contents can be performed from the lower portion of the container body and a can lid of a conventional mode can be used and hence, it is possible to make use of most of an existing filling facility.

A manufacturing method of a container sealing structure described in claim 14 is characterized by including a step for integrally forming a cylindrical portion which is substantially coaxial and makes one portion thereof have a diameter different from diameters of other portions, a step for forming a triplicate wall consisting of an inner wall, an intermediate wall and an outer wall in which the cylindrical portion is subjected to the fold-back deformation by the compression manipulation of the cylindrical portion in the axial direction such that a portion of the cylindrical portion having a small diameter is arranged inside a portion of the cylindrical portion having a large diameter, and a step for forming an easily breakable portion on the cylindrical portion.

A manufacturing method of a container sealing structure described in claim 15 is characterized by forming the portion of the cylindrical portion having the large diameter by a diameter expanding manipulation or forming the portion of the cylindrical portion having the small diameter by a diameter narrowing manipulation.

As the diameter expanding manipulation, various known diameter expansion methods such as, for example, a bulging forming method, a rotary roller forming method, a liquid pressure method, an electric discharge forming method, an explosion forming method, an incremental forming method can be used. The diameter narrowing manipulation can be performed by a rotary roller forming method, a swaging forming method and the like.

A manufacturing method of a container sealing structure described in claim 16 is characterized in that the portion which is folded back by the axial compression manipulation of the cylindrical portion is formed with a thickness smaller than thicknesses of other portions.

Particularly, when the cylindrical portion is made of a metal material, by performing ironing forming using a punch which has a bulged portion partially and an ironing die, it is possible to form a thin wall portion partially.

In forming the triplicate wall, since a fold-back expected portion is thin and only this portion is preferentially deformed by the compression manipulation and hence, the deformation does not affect other portions whereby the cylindrical portion can obtain a stable shape in each compression manipulation. Further, it is also possible to obtain an advantageous effect that power necessary for molding can be reduced.

A manufacturing method of a container sealing structure described in claim 17 is characterized in that thread engaging portions or undercut engaging portions are formed on the cylindrical portion by applying thread forming or undercut forming to the triplicate wall.

In the thread forming or the undercut forming, forming jigs are arranged inside and outside the triplicate wall and are operated such the forming jigs are meshed with each other and hence, the thread engaging portion or the undercut engaging portion is temporarily formed on the triplicate wall.

A manufacturing method of a container sealing structure described in claim 18 is characterized in that threads or undercut shapes are applied to a portion which is expected to become a cap and a portion which is expected to become a pouring portion preliminarily, the triplicate wall is formed by generating the deformation which folds back a cylindrical portion, and the threads or the undercut shapes are engaged with each other respectively.

For example, the threads or the undercut shapes can be preliminarily formed by injection molding or the like using a plastic material and hence, it is possible to obtain an advantageous effect that a step for forming the threads or the undercut structure which follows the formation of the triplicate wall can be omitted.

A manufacturing method of a container sealing structure described in claim 19 is characterized by including a step in which a panel shape which becomes resilient by a torsional force is formed in a midst portion of a path which continuously connects a portion where threads are formed and a portion where threads with which the threads are engaged are formed at a portion which is expected to become the cap portion.

### BRIEF DESCRIPTION OF THE DRAWINGS

FIG. 1 is a schematic cross-sectional view showing a container sealing structure of an embodiment 1.

FIG. 2 is a schematic cross-sectional view of the container sealing structure of the embodiment 1 in a state that a cap portion is separated.

FIG. 3 is a flowchart showing manufacturing steps of the container sealing structure of the embodiment 1.

FIG. 4 is a schematic explanatory view showing an abstract of bulging in diameter enlarging forming.

FIG. 5 is a schematic explanatory view showing an abstract of necking in diameter narrowing forming.

FIG. 6 is a schematic explanatory view showing the difference of deformation steps in fold-back forming.

FIG. 7 is a schematic explanatory view of the sealing structure in which an easily breakable portion (slit) is formed in the embodiment 1.

FIG. 8 is a schematic explanatory view showing another modification of the embodiment 1.

FIG. 9 is a schematic cross-sectional view showing a container sealing structure of an embodiment 2.

FIG. 10 is a schematic cross-sectional view of preform in a preceding stage leading to the completion of the embodiment 2.

FIG. 11 is a schematic cross-sectional view showing a container sealing structure of an embodiment 3.

FIG. 12 is a schematic cross-sectional view of preform in a preceding stage leading to the completion of the embodiment 3.

FIG. 13 is a schematic explanatory view showing an example in which a pulling tab for opening an easily breakable portion by cutting is provided.

FIG. 14 is a schematic explanatory view showing a container sealing structure of an embodiment 4.

FIG. 15 is a schematic explanatory view showing the container sealing structure of the embodiment 4 in a state that a cap portion is separated.

FIG. 16 is a schematic explanatory view showing a modification of the embodiment 4.

FIG. 17 is a schematic explanatory view showing another modification of the embodiment 4.

FIG. 18 is a schematic explanatory view showing a container sealing structure of an embodiment 5.

FIG. 19 is a schematic explanatory view of an essential part of the container of the embodiment 5.

FIG. 20 is a cross-sectional view of an essential part of a container of an embodiment 6.

FIG. 21 is a cross-sectional view of a container of a modification of the embodiment 6.

### BEST MODE FOR CARRYING OUT THE INVENTION

Hereinafter, container sealing structures according to embodiments of the present invention are explained in detail in conjunction with drawings.

### Embodiment 1

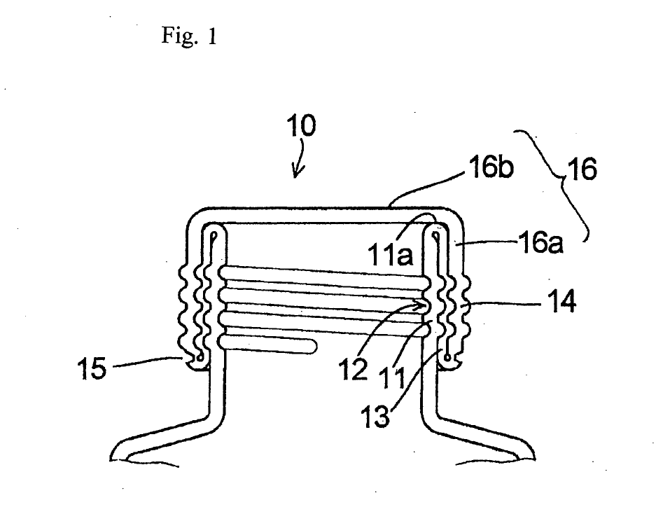

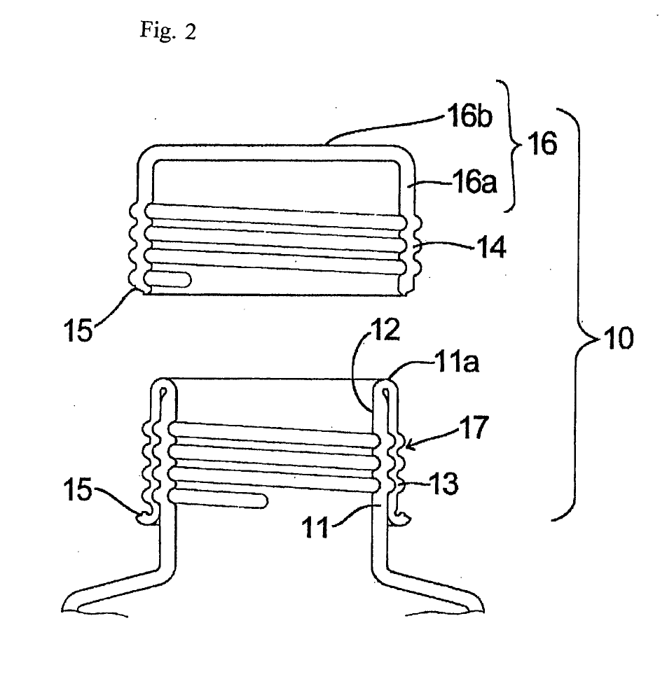

FIG. 1 is a cross-sectional view of an essential part of a container provided with a container sealing structure of an embodiment 1 of the present invention and FIG. 2 is a cross-sectional view of an essential part of the container in a state that a cap portion is separated.

In this embodiment 1, an example in which threads are formed in an inner wall, an intermediate wall and an outer wall is illustrated.

In FIG. 1 and FIG. 2, numeral 10 indicates the container sealing structure of the embodiment 1, numeral 11 indicates an inner wall, numeral 12 indicates a pouring portion, numeral 13 indicates an intermediate wall which is formed by folding back at an end portion 14a of the inner wall 11, numeral 14 indicates an outer wall which is formed by folding back upwardly from a lower end of the intermediate wall 13, numeral 15 indicates an easily breakable portion which is formed by providing scores in a thin-wall-thickness groove shape at a lower end side of the intermediate wall 13, numeral 16 indicates a cap portion which includes a cylindrical cover portion 16a which is connected with the easily breakable portion 15 and is extended integrally from the easily breakable portion 15 and a disk-like top plate portion 16b which covers an opening of the pouring portion 12, and numeral 17 indicates thread engaging portions which are respectively formed on the intermediate wall 13 and the cover portion 16a of the cap portion 16.

The sealing structure of the present invention is a cap structure which is used in a juice can, a beer can, a carbonate beverage can, a black tea can or the like. A metal material, a metal material such as aluminum alloy, steel or the like which has an inner surface or an outer surface thereof coated with a resin layer or the like, a plastic material is preferably applicable to the sealing structure. As a shape of the container body, a shape having a circular columnar contour or a rectangular columnar contour is preferably applicable.

As shown in the drawing, the container sealing structure 10 of the embodiment 1 has the triplicate cylindrical structure in which the inner wall 11, the intermediate wall 13 and the outer wall 14 are respectively continuously and integrally formed, wherein the outer wall 14 is arranged in a separable manner from the intermediate wall 13 by way of the easily breakable portion 15 which is arranged at a lower end connecting portion side between the intermediate wall 13 and the outer wall 14.

In the sealing structure 10 of the embodiment 1, it is preferable that heights of the pouring portion 12, the intermediate wall 13 and the cap portion 16 which are continuously and integrally formed are set to approximately 5 to 50 mm, for example and a diameter of the cap portion 16 is set to approximately 20 to 100 mm, for example.

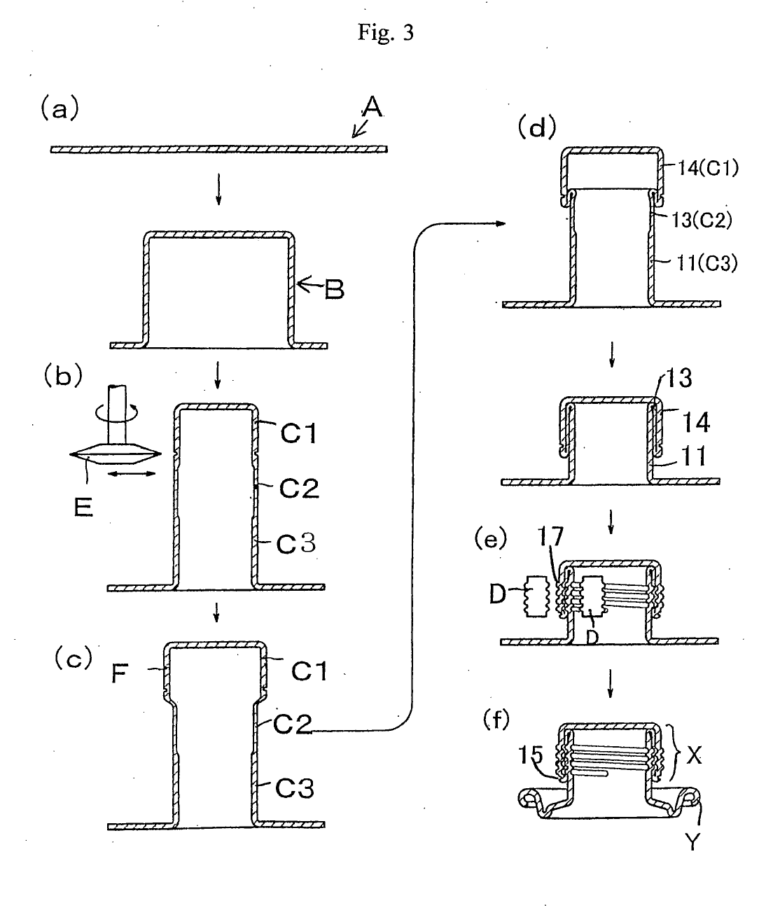

The sealing structure 10 of the embodiment 1 having such a structure can be manufactured using following steps (a) to (e) shown in a manufacturing flowchart in FIG. 3, for example.

(a) A metal plate A such as an aluminum alloy plate or the like is formed into a cylindrical cup (cylinder portion) B by deep drawing.

(b) Redrawing is applied to the cylindrical cup B using a punch having a partially bulged portion at a center thereof and, at the same time, a center portion C2 of the cylindrical cup (cylinder portion) B is thinned by bringing the bulged portion of the above-mentioned punch into contact with the center portion C2 thus forming an upper portion C1, the thinned center portion C2 and a lower portion C3 on the cylindrical cup (cylindrical portion) B.

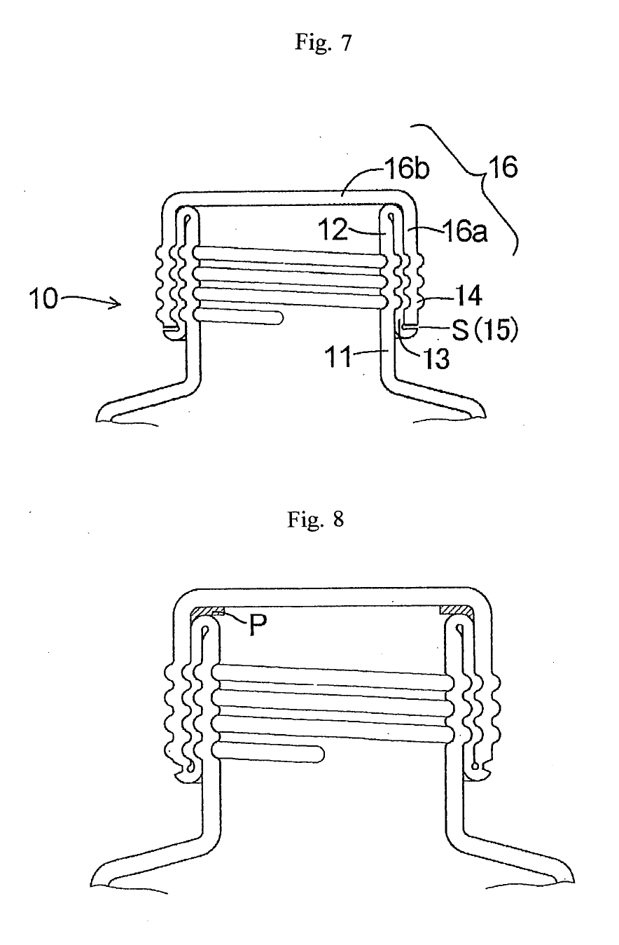

Further, the easily breakable portion 15 having the thin-wall groove portion (scores) which is formed using a blade-like roll E or the like or a cut portion (slit) S which is formed by partially forming through holes therein is formed at a breaking expected portion between the outer wall 14 and the intermediate wall 13 below a projecting portion formed after thread forming, that is, below the upper portion C1 of the cylindrical cup (cylindrical portion) B (FIG. 7). The easily breakable portion 15 is formed by moving the blade-like roll E around the cylindrical cup (cylindrical portion) B such that the easily breakable portion 15 is positioned below a portion which constitutes the outer wall 14 after the fold-back operation.

Here, the step for forming the easily breakable portion 15 may be performed after a diameter expanding step described in the following (c).

Here, the cut portion (slit) implies a slit-like portion, a hole-like portion or a cut-like portion in which through holes are partially formed and is formed at the easily breakable portion 15.

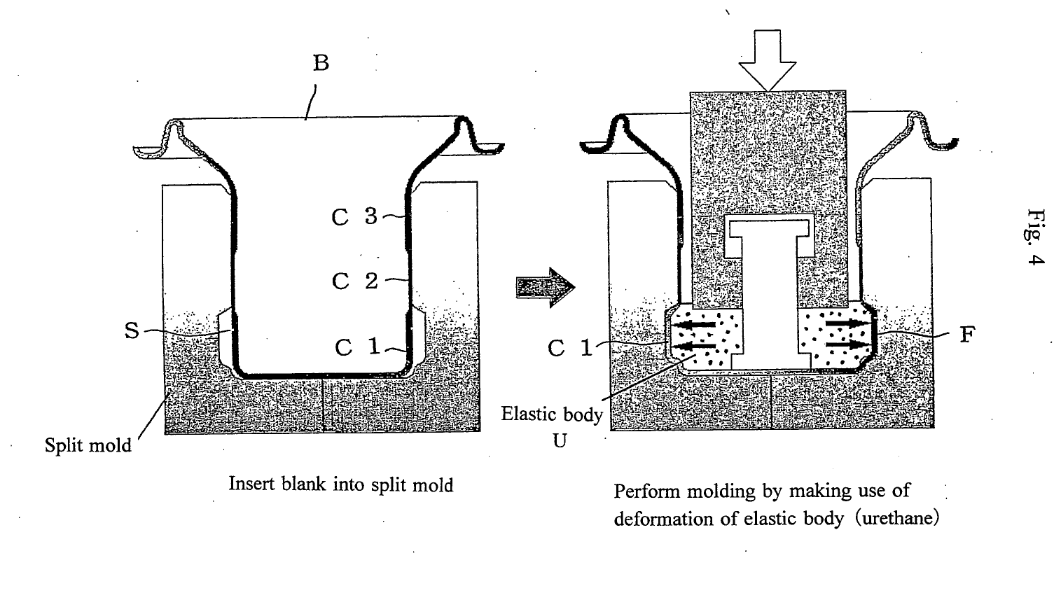

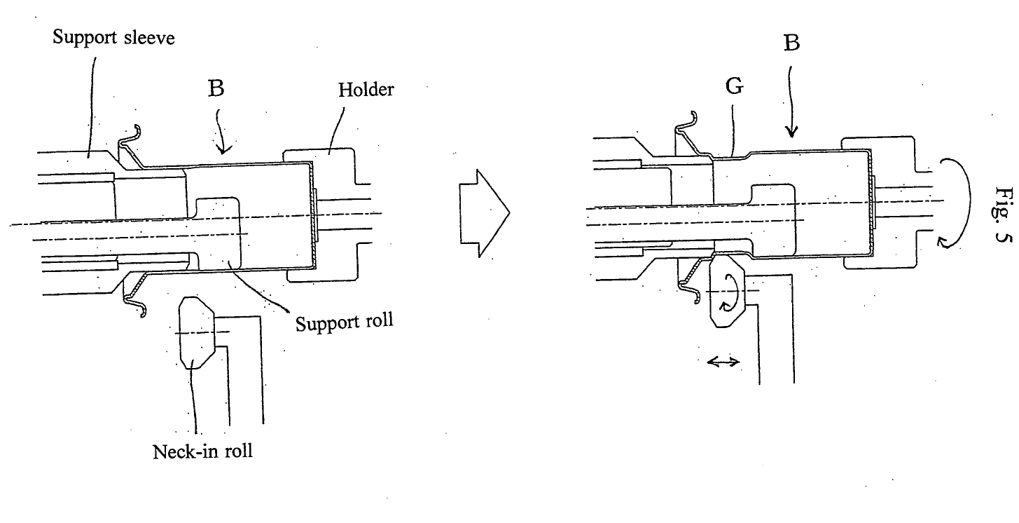

(c) The upper portion C1 of the cylindrical cup (cylindrical portion) B which constitutes a blanked-member is inserted into a split mold and, thereafter, with means such as bulging forming (see FIG. 4) or the like, using an elastic body U made of urethane or the like, the diameter of the upper portion C1 is enlarged from an inside to an outside thereof due to the deformation of the elastic body U thus forming an enlarged diameter portion f. Alternatively, with the use of necking means (see FIG. 5) or the like, the diameter of the cylindrical cup B is narrowed from the outside to the inside using a neck-in roll and a support roll thus forming a narrow diameter portion G.

(d) Next, pressure is applied to a head portion of the cylindrical cup (cylindrical portion) B so as to form a projecting portion X having the triplicate cylindrical wall consisting of the inner wall 11, the intermediate wall 13 and the outer wall 14 such that the center portion C2 which is formed at a center portion of the cylindrical cup B in the height direction constitutes an intermediate wall 13 and the upper portion C of the cylindrical cup B is arranged at the outermost side thus forming the outer wall 14.

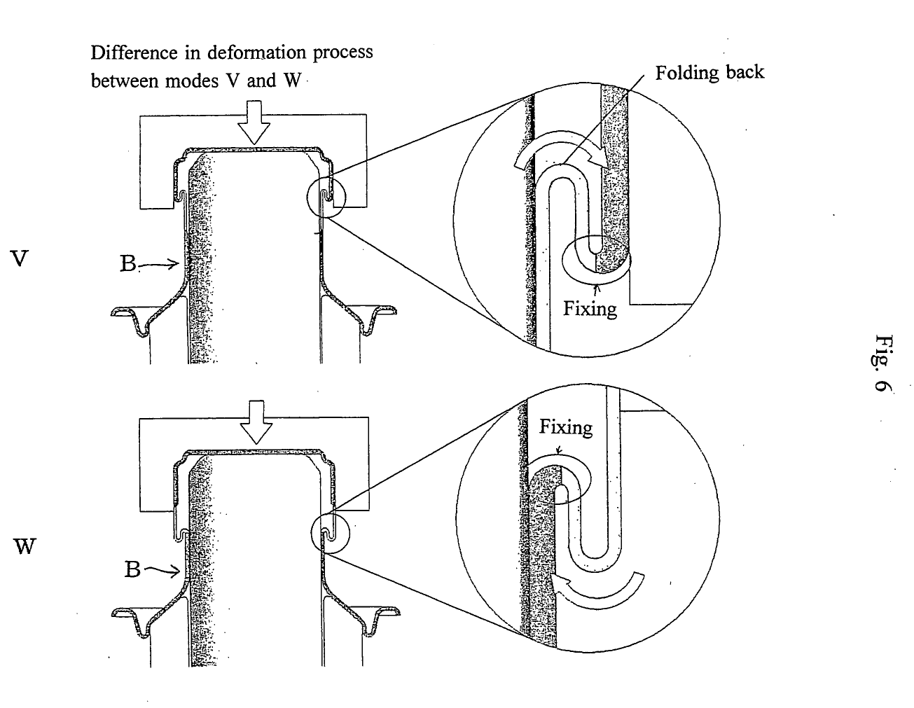

In such fold-back forming, there exists a case in which using the upper portion C1 of the cylindrical cup (cylindrical portion) B as a large diameter portion, the center portion C2 is folded back to the outside using a lower end of the large diameter portion C1 as a starting point (mode V shown in FIG. 6) and a case in which using the upper portion C1 and the center portion C2 of the cylindrical cup (cylindrical portion) B as large diameter portions, the center portion C2 is folded back to the inside using a lower end of the center portion C2 as a starting point (mode W shown in FIG. 6).,

Both of the mode V and the mode W form the same structure after forming as shown in FIG. 3(d). Here, in this fold-back forming, by preliminarily performing the heat treatment of the at least the above-mentioned center portion C2 partially using high frequency induction heating or the like, it is possible to soften the material thus facilitating the forming.

(e) Next, thread forming jigs Dare brought into pressure contact with the inside and the outside of the projecting portion X to perform thread forming thus forming the thread engaging portion 17 whereby the sealing structure 10 of the embodiment 1 shown in FIG. 1 is completed.

Here, the step for forming the above-mentioned easily breakable portion 15 may be performed after forming the thread engaging portion 17.

Although the cross section of the thread portion in the present invention is depicted such that crests of the threads project outwardly in the drawings including FIG. 1, the thread portion may be formed without limiting the direction of the crests of the threads to this direction. For example, the crests of the threads may project inwardly.

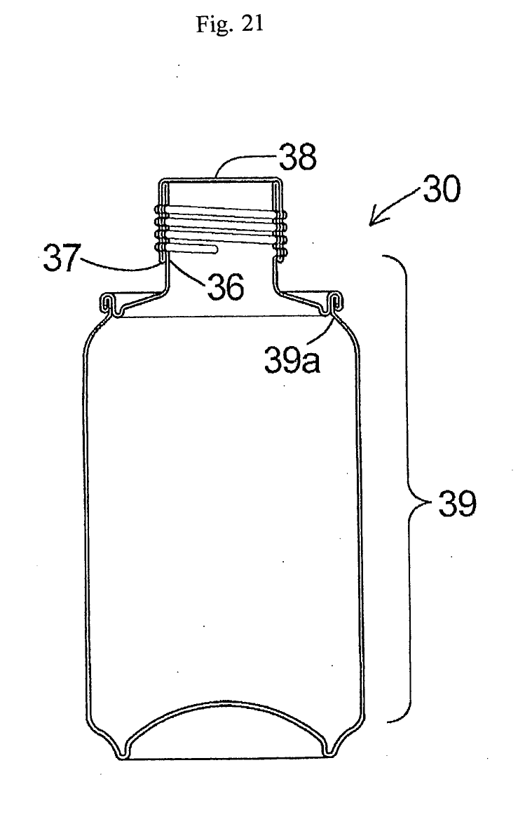

(f) To enable mounting of the sealing structure to an end portion of the metal can by the seaming manipulation, a curl portion Y is formed on an outer peripheral end of the sealing structure (illustrated in FIG. 21). The formation of the curled portion Y is performed in a normal method and may be formed in any one of above-mentioned stages (b) to (f).

Further, particularly when an organic coated metal sheet is used as a material, for the purpose of maintaining an adhesive strength of coating, it is possible to suitably perform the heat treatment in the final stage or in the intermediate stage of the steps.

Here, as shown in FIG. 8, by additionally providing a sealing material P to the sealing structure of the embodiment 1, it is possible to enhance the sealing property after resealing.

### Embodiment 2

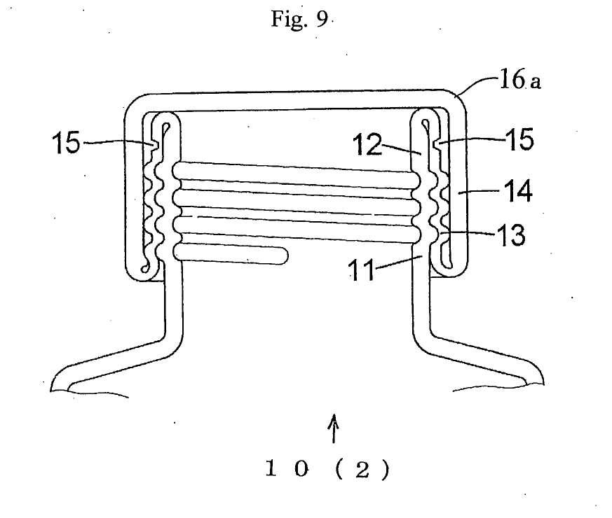

The sealing structure 10(2) shown in FIG. 9 is, in the sealing structure of the above-mentioned embodiment 1, characterized in that the thread engaging portion 17 is formed on the inner wall 11 and the intermediate wall 13, while the outer wall 14 is formed into a flat cover portion 16a. A manufacturing method of the sealing structure 10(2) of the embodiment 2 is as follows.

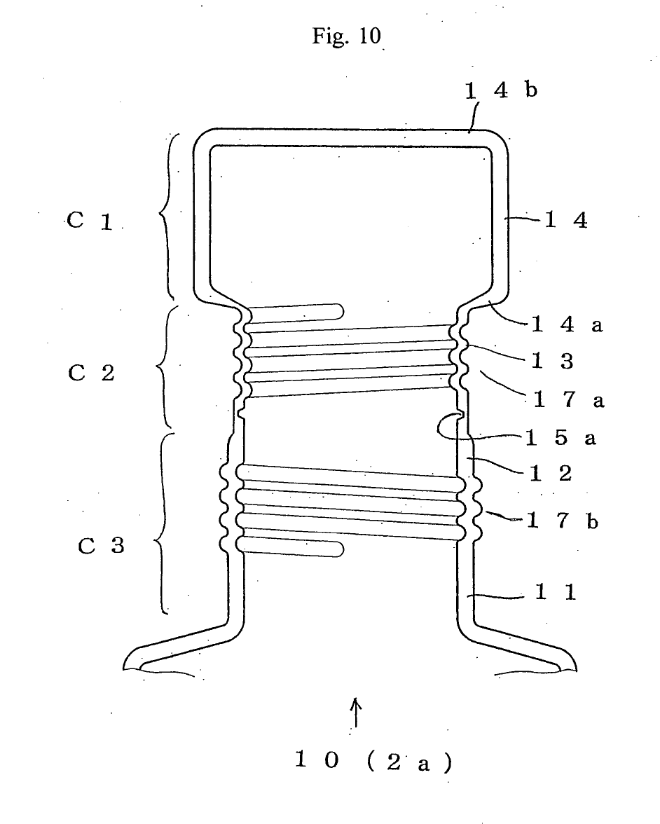

The cylindrical portion B shown in FIG. 10 is formed by an injection molding method or the like using a plastic material or the like as a material.

The cylindrical portion 10 (2a) is constituted of the upper portion C1 having a large diameter and the center portion C2 and the lower portion C3 having diameters smaller than the diameter of the upper-portion C1, wherein these portions are substantially coaxially and integrally formed.

Threads 17b are formed on the lower portion C3. Threads 17a having a threading direction opposite to the threading direction of the threads 17b and having the same pitch as the threads 17b and the easily breakable portion 15a are formed on the center portion C2. Further, a thickness of the center portion C2 is formed smaller than a thickness of the upper portions C1 and C3.

By applying pressure to a head portion 14b, the fold-back deformation is started using a lower end 14a of the upper portion C1 as a starting point and the center portion C2 which is thinner than other portions is sequentially folded back.

As a result, the threads 17a formed on the center portion C2 are inverted and become threads having the same threading direction and the same pitch as the threads 17b and are engaged with the threads 17b thus completing the sealing structure 10 (2) shown in FIG. 9.

Here, it is desirable to suitably apply the heat treatment to sealing structure 10(2) formed in this manner for releasing a residual stress generated by forming.

### Embodiment 3

The sealing structure 10(3) shown in FIG. 11 is, in the sealing structure of the above-mentioned embodiment 1, characterized in that thread engaging portions 17 are formed on an outer wall 14 and an intermediate wall 13 and an inner wall 11 is formed into a flat pouring portion 12. A manufacturing method of such a sealing structure 10(3) of the embodiment 3 is as follows.

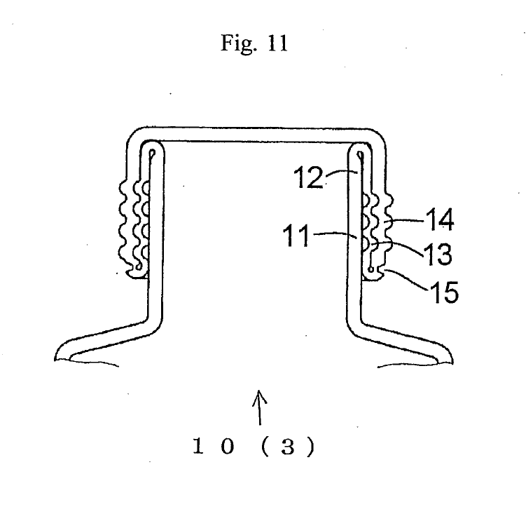

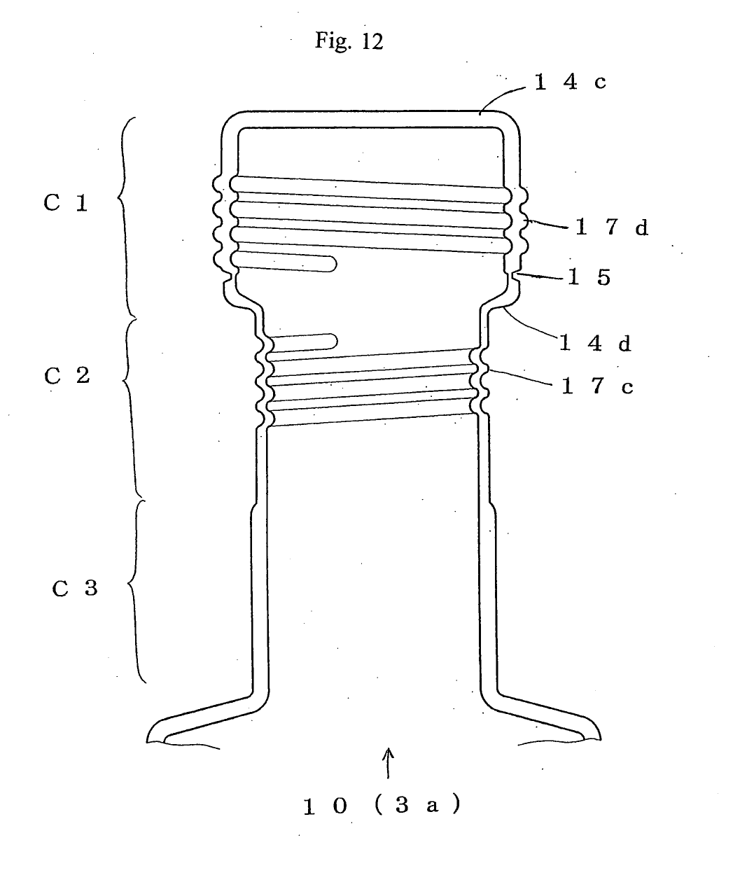

A cylindrical portion 10(3a) shown in FIG. 12 is formed by an injection molding method using a plastic material or the like as a material.

The cylindrical portion 10 (3a) is constituted of an upper portion C1 having a large diameter and a center portion C2 and a lower portion C3 having a diameter smaller than the diameter of the upper portion C1, wherein these portions are formed substantially coaxially and integrally.

Threads 17d and an easily breakable portion 17 are formed in the upper portion C1. Threads 17c having a threading direction opposite to a threading direction of the threads 17d and having an equal pitch as a pitch of the threads 17d are formed on the center portion C2. Further, a thickness of the center portion C2 is set smaller than thicknesses of the portions C1 and C3.

By applying pressure to a head portion 14c, the fold-back deformation is started using a lower end 14d of the upper portion C1 as a start point and the center portion C2 having the thickness smaller than the thickness of other portions is sequentially folded back.

As a result, the threads 17c formed on the center portion C2 are reversed and become threads which have the same threading direction as the threads 17d and have the equal pitch as the threads 17d and are engaged with the threads 17d thus completing the sealing structure 10(3) shown in FIG. 11.

Here, it is desirable to perform the suitable heat treatment to the sealing structure 10 (3) which is formed in this manner for releasing a residual stress generated by forming.

Next, a method for using the structure described in the embodiments 1 to 3 is explained.

First of all, a user pinches and rotates the outer wall 14 (cap portion 16) of the sealing structure thus imparting a shearing force to the outer wall 14. Accordingly, the easily breakable portion 15 is broken and the cap portion 16 is independently rotated with respect to the intermediate wall 13 and hence, the sealing structure is opened. The cap portion 16 is separated as shown in FIG. 2 and hence, the user can pour a veberage in the container into a cup from the pouring portion 12 or can directly drink the veberage.

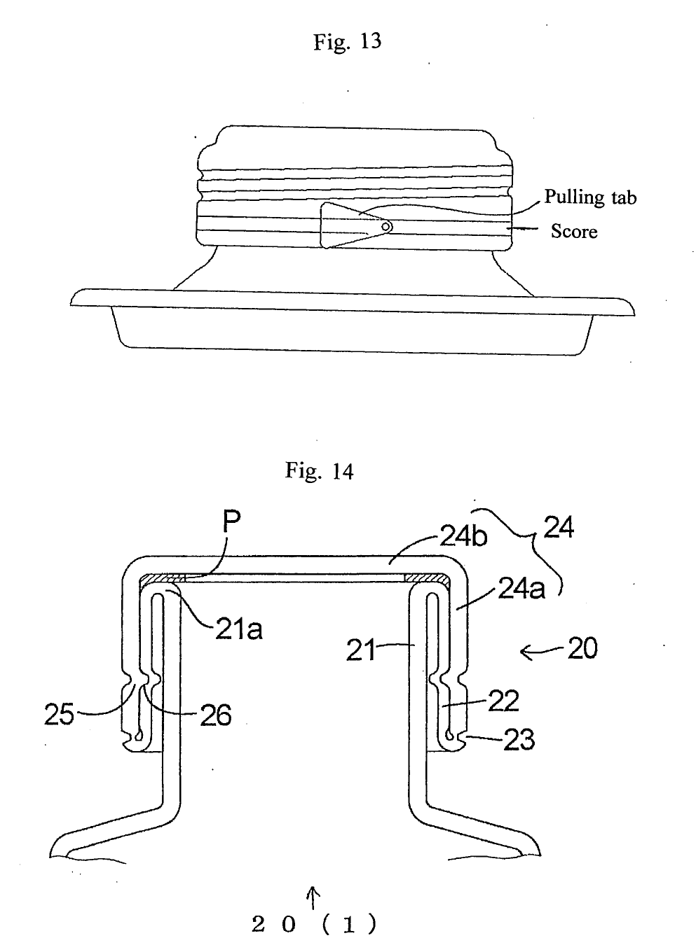

Here, a separation jig such as a pulling tab may be preliminarily formed on the easily breakable portion 15 for cutting the thin-wall portion by pulling and the outer wall 14 (cap portion 16) may be separated from a lower end of the intermediate wall 13 by pulling the pulling tab (see FIG. 13).

When some veberage remains in the container, the intermediate wall 13 is capped with the outer wall 14 (cap portion 16) and the outer wall 14 is rotated and hence, both portions are surely fixed to and sealed to each other due to the thread engaging portions 17 formed on the portions respectively.

Since the container sealing structure of the embodiments 1 to 3 has the above-mentioned structure and hence, the container sealing structure can have following excellent functions described hereinafter.

(1) Since the outer wall 14 (cap portion 16) and the inner wall 11 (pouring portion 12) are integrally formed, it is possible to obtain the excellent productivity at the time of manufacturing containers and the excellent durability during the transportation of the containers.

(2) Since the easily breakable portion 15 is formed in the boundary portion between the outer wall 14 (cap portion 16) and the inner wall 11 (pouring portion 12), even the infant, the aged person or the like can surely open the container by manipulating the easily breakable portion 15 while observing the broken state and, at the same time, it is possible to maintain the container hygienically by easily mounting the cap portion 16 to the intermediate wall 13 of the pouring portion 12 at the time of resealing.

(3) By making use of the resiliency of the intermediate wall 13, the mounting manipulation of the cap portion 16 after opening the container by separating the easily breakable portion 15 can be surely performed.

(4) Since the intermediate wall 13 and the cap portion 16 are replaceably mounted to each other by way of the thread engaging portions 17, it is possible to hygienically maintain the veberage which remains in the container after opening the container by separating the easily breakable portion 15 thus exhibiting the excellent handling property of the container sealing structure.

### Embodiment 4

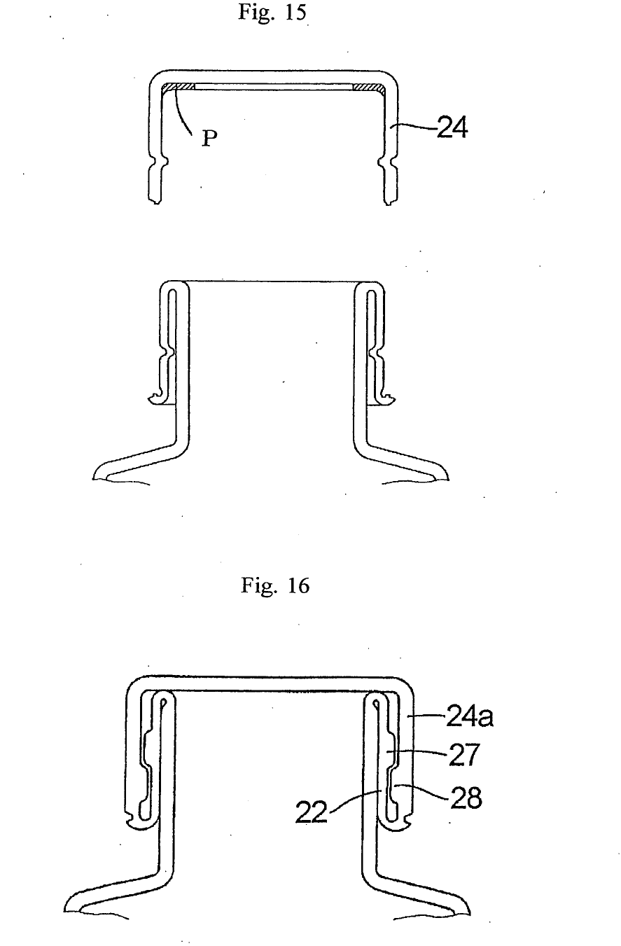

FIG. 14 is a cross-sectional view of an essential part of a container sealing structure of an embodiment 4 of the present invention and FIG. 15 is a cross-sectional view of the essential part in a state that a cap portion is removed.

In FIG. 14 and FIG. 15, numeral 20 indicates the container sealing structure of the embodiment 4, numeral 21 indicates a pouring portion, numeral 22 indicates an intermediate wall which is formed in a cylindrical shape by folding back at an end portion 21a of the pouring portion 21, numeral 23 indicates an easily breakable portion which is formed around a lower end side of the intermediate wall 22 or a cover portion 24a in a thin-wall groove shape, numeral 24 indicates a cap portion which includes the cylindrical cover portion 24a which is extended to the intermediate wall 22 contiguously with the easily breakable portion 23 and a top plate portion 24b which covers an opening of the pouring portion 21, numeral 25 indicates a fitting engaging portion which is formed on a lower end of a peripheral wall of the cap portion 24 in a projecting manner toward the inside, numeral 26 indicates a recessed portion which is formed in the intermediate wall 22 and to which the fitting engaging portion 25 is engaged, and symbol P indicates a donut-shaped sealing material made of an elastic body such as rubber or synthetic resin which is arranged on the top plate portion 24b of the cap portion 24 by adhesion or fitting.

Here, the container sealing structure 20(1) of the embodiment 4 differs from the container sealing structure of the first embodiment with respect to following points.

(i)After opening the container, the cap portion 24 is arranged to be replaceably fitted on the intermediate wall 22 by way of the fitting engaging portion 25 (formation of the fitting engaging portion in a so-called undercut method).

(ii)The sealing material P is arranged on the top plate portion 24b of the cap portion 24.

Also in the sealing structure 20(1) of the embodiment 4, it is desirable that the sealing structure 20(1) is formed such that heights of the pouring portion 21, the intermediate wall 22 and the cap portion 24 which are continuously and integrally formed are approximately 5 to 50 mm, for example, and a diameter of the cap portion 24 is approximately 20 to 100 mm, for example.

The fitting engaging portion 25 and the recessed portion 26 into which the fitting engaging portion 25 is fitted may be formed in an undercut shape in place of the thread portions in the manufacturing method explained in conjunction with the above-mentioned embodiment 3.

Here, after the easily breakable portion 23 is broken, a diameter of the intermediate wall 22 is resiliently enlarged so that the recessed portion 26 formed in the intermediate wall 22 and the fitting engaging portion 25 formed on the lower end side of the cap portion 24 are resiliently engaged with each other.

The sealing-material P is formed in a thin-wall donut disc-like shape using rubber, synthetic resin or the like as a material thereof, for example, wherein the sealing material P is arranged to cover the top plate portion 24b inside the cap portion 24 by fitting or adhesion. Further, in the above-mentioned FIG. 3, the sealing material P may be preliminarily applied or adhered to an inner periphery of the lower end portion of the thin-wall portion C at the center portion of the cylindrical cup B.

Due to such a constitution, in a later step, the sealing material P is positioned at an end portion 21a of the pouring opening 21 and is configured to be interposed between an inner surface of the cap portion and the pouring portion. Alternatively, with the use of a coated sheet or a laminated sheet which applies an organic coating to an inner surface side thereof as a metal material preliminarily, it is possible to make the coated material play a role of a sealing material. Accordingly, at the time of covering the pouring portion 21 with the cap portion 24 which is separated by breaking the easily breakable portion 23, the sealing material P which is formed on the end portion 21a of the pouring portion 21 is hermetically adhered so that leaking of a liquid inside the container can be effectively prevented.

The easily breakable portion 23 which is formed by arranging cut portions (slits) S in such a slit form or the like along a peripheral wall of the lower end side of the cap portion 24 can be formed by cutting perforations at the circumferential position of the lower end side of the outer peripheral wall of the cap portion 24 using a blade role or the like, for example, after integrally forming the container body.

Since such slits S are formed in the easily breakable portion 23, a person having a weak physical strength can also easily break the easily breakable portion 23. Here, the easily breakable portion 23 may be formed by continuously arranging a thin-wall portion without forming complete openings.

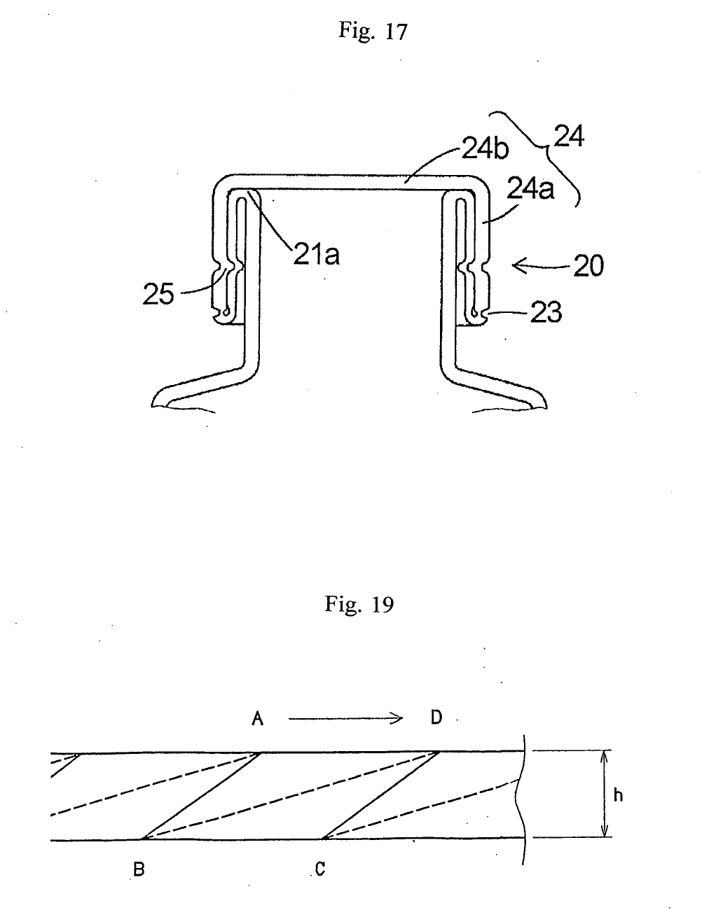

As shown in FIG. 16, with respect to the fitting engaging portion 25 and the recessed portion 26 into which the fitting engaging portion 25 is fitted, projecting portions 27, 28 are respectively formed on the intermediate wall 22 and the cover portion 24a and these projecting portions 27, 28 are fitted with each other at a lower end and an upper end thereof. Further, as shown in FIG. 17, the sealing material P may be omitted.

The container sealing structure of the embodiment 4 has the above-mentioned constitution and hence, the container sealing structure can obtain following excellent functions.

(1) Since the container sealing structure is continuously and integrally formed, there is no possibility that the cap portion is removed due to the vibrations during the transportation whereby the sealing structure exhibits the excellent durability and, at the same time, the container sealing structure can be manufactured easily.

(2) By providing the easily breakable portion 23 which has through holes in a slit shape, a hole shape, a cut shape or the like partially, even a person having a weak strength such as an infant, an aged person or the like can easily break the easily breakable portion 23 thus exhibiting the excellent opening property.

(3) By effectively making use of the resiliency of the intermediate wall 22, after breaking the easily breakable portion 23 and opening the container, the mounting manipulation of the cap portion 24 can be surely performed, the cap portion 24 can be mounted with the one-touch manipulation which only pushes the cap portion 24 having the fitting engaging portion 25 into the intermediate wall 22 whereby even the infant and the aged person can easily handle the cap.

(4) Since the scores and through holes in a slit shape or a hole shape are formed in the easily breakable portion 23, in manufacturing the container sealing structure, the adjustment of a wall thickness of the container is unnecessary and, at the same time, the scores or the through holes can be easily formed using blade rollers or the like for perforation and hence, the containers or the like can be manufactured at a low cost.

(5) Since the sealing material P is arranged on the top plate portion 24b of the cap portion 24, the sealing property of the cap portion 24 at the time of resealing the pouring portion 21 can be enhanced whereby even when the container body is tilted or becomes upside down or during the transportation, there is no possibility that some veberage remaining in the container leaks out and hence, the container can be hygienically maintained.

### Embodiment 5 Torsional Resilient Panel

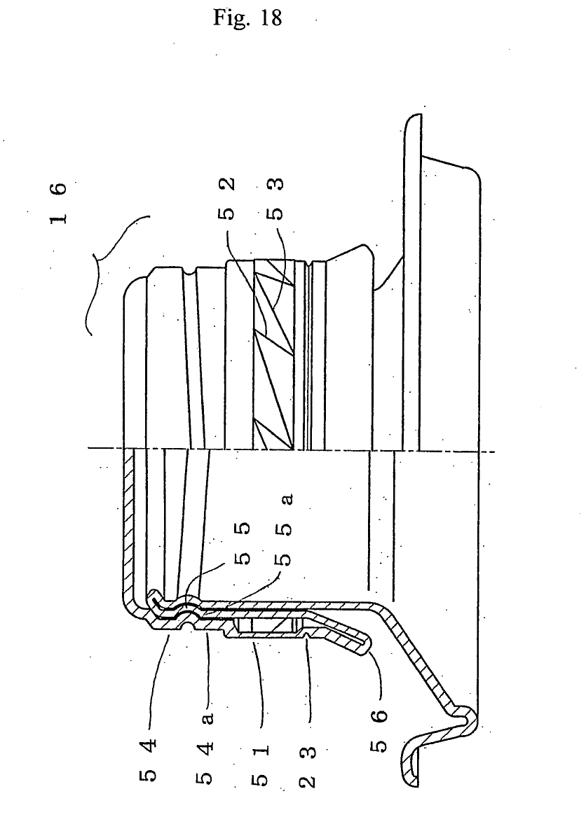

FIG. 18 is a partial cross-sectional view of a container sealing structure of an embodiment 5 of the present invention.

The container sealing structure of the embodiment 5 of the present invention differs from the sealing structure of the embodiment 1 with respect to a point that in the vicinity of an easily breakable portion 23 formed on an outer wall 14, a torsional resilient panel 51 consisting of crests 52 and valleys 53 is formed. Although various shapes are applicable as a shape of the torsional resilient panel, FIG. 18 shows one example thereof, wherein FIG. 18 illustrates a case in which the torsional resilient panel 51 is formed on a cap portion 16.

The position where the torsional resilient panel is formed is disposed at a midst portion of a path which connects threads formed in the cap portion 16 and threads which are engaged with the above-mentioned threads and hence, the panel is deflected by twisting the cap portion and the cap portion 16 is rotated by an amount corresponding to the deflection and hence, a rotational displacement is generated between engaging threads whereby a thread thrust can be generated.

The midst portion of the path which connects the threads formed in the cap portion 16 and the threads which are engaged with the threads implies any midst portion of the path which starts from a lower end portion 54a of a thread portion 54 of the cap portion 16 to a lower end portion 55a of a thread portion 55 in the intermediate wall by way of a fold-back end portion 56 positioned below the end portion 54a in FIG. 18, for example, FIG. 19 is a partially enlarged view for explaining the torsional resilient panel. Although a panel width h can be suitably determined based on a length of the cap portion 16 or the like, the panel width h is usually approximately ⅕ to 1/25 of a diameter of the cap portion 16. Using a parallelogram ABCD formed of polygonal lines (in a strict sense, since the parallelogram is on a cylindrical surface, opposing sides assume a slightly torsional positional relationship) as a basic unit, these basic units are formed continuously on the circumference. There exists an optimum range with respect to the number n of parallelograms ABCD on the circumference depending on a diameter, a thickness, strength characteristics and the like of the cap portion 16. Although the number n of parallelograms ABCD is not specifically limited, to show one example, when a material is aluminum alloy, the diameter of the panel portion is 33 mm, the wall thickness of the panel portion is 0.28 mm and the panel width h is 3 mm, the number n of parallelograms ABCD assumes n=14 to 18. Although it is self-explanatory, a length of one side BC is 1/n of the circumference of the cap portion. An angle ABC can be set to a value which falls within a range of 5° to 9°, and more particularly within a range of 15° to 70°. The side AB, the side BC, the side CD and the side DA form the crests (indicated by a solid line) as viewed from the outside of the cap portion 16 and the side BD forms the valley (indicated by a broken line).

In such a torsional resilient panel, when the AD side is twisted in the direction from A to D while fixing the BC side in FIG. 19, a triangle ABD and a triangle CBD are respectively deformed in an overlapped manner toward the inside of the cap portion while deforming the torsional resilient panel such that the panel width h is decreased and hence, it is possible to generate the torsional displacement between an upper portion and a lower portion of the panel.

Such a torsional resilient panel is configured in a pattern which simply repeats the crests and the valleys and hence, the crests and the valleys can be sequentially formed by moving forming rollers arranged at the inside and the outside of the panel along the circumference while making the forming rollers mesh with each other, for example. Usually, it is preferable to perform this step in a stage before forming the triplicate wall. Further, to deflect the torsional resilient panel with a particularly low torsional torque, this portion may be formed thin preliminarily or may be softened by the heat treatment preliminarily. Since a tensile stress generated by the thread thrust is added to the shearing stress generated by the torsion, it is possible to obtain the manner of operation and the advantageous effect that the easily breakable portion 23 formed in the vicinity of the torsional resilient panel can be easily broken.

### Embodiment 6 Container

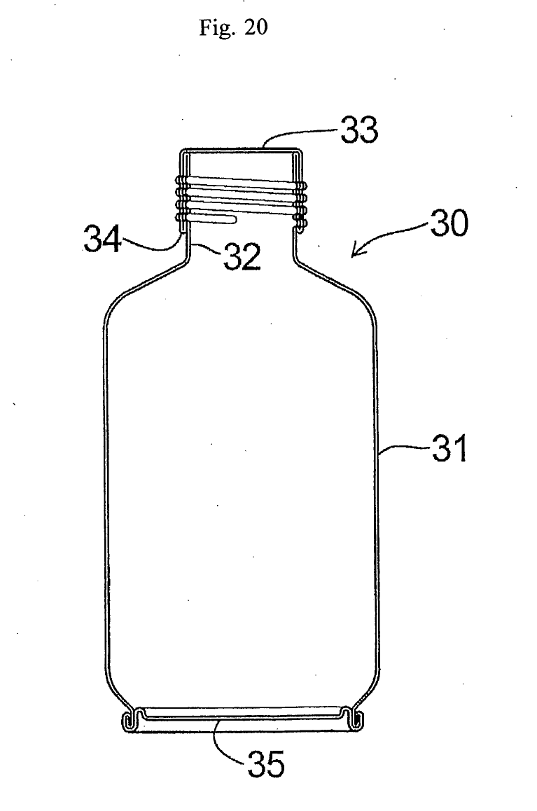

FIG. 20 is a cross-sectional view of an essential part of a container provided with a container sealing structure according to an embodiment 6 of the present invention and FIG. 21 is a cross-sectional view of a modification of the container provided with the container sealing structure.

In FIG. 20 and FIG. 21, numeral 30 indicates the container provided with the container sealing structure according to the embodiment 6 of the present invention, numeral 31 indicates a peripheral wall portion, numeral 32 indicates a pouring portion, numeral 33 indicates a cap portion which is continuously and integrally formed on an upper portion of the pouring portion 32 by way of an easily breakable portion 34 formed in a thin-wall groove shape or the like, numeral 35 indicates a bottom lid portion which has a brim-portion thereof fixed by seaming to a lower end portion of the peripheral wall portion 31 of a container body which is opened (in case of FIG. 20).

FIG. 21 is a cross-sectional view showing a state in which the sealing structure and the container body 39 are connected to each other by seaming at a container opening end portion 39a. Although the container 30 is formed using a metal material such as aluminum alloy, steel or the like as a material thereof, it may be formed using a plastic material such as polyethylene, polyethylene terephthalate or the like. Depending on the usage, the manufacturing cost and the like, various molding methods such as deep drawing, ironing, extrusion molding, injection molding and the like and various materials can be selectively used.

In FIG. 20 and FIG. 21, the easily breakable portion 34, 37 may be provided with a tab which constitutes a pulling element for pulling the portion or a metal wire or the like which circles along the inside of the thin-wall groove portion. By pulling such a tab or such a metal wire or the like, the easily breakable portion 34 can be easily unsealed.

After separating the cap portion 33, 38 from the pouring portion 32, 36 by cutting the easily breakable portion 34, 37, the cap portion can be fitted on the pour portion 32, 36 by pushing so as to enable resealing.

After filling a beverage or the like which constitutes the contents into the container body, using known connecting means, the bottom lid portion 35 is seamed to the lower end of the peripheral wall portion 31 of the opened container body when the bottom lid portion 35 is made of a metal material and is connected to the lower end of the peripheral wall portion 31 of the opened container body by welding or adhesion when the bottom lid portion 35 is made of a plastic material.

The container 30 provided with the container sealing structure according to the embodiment 6 has the above-mentioned constitution and has following functions.

(1) When the whole container 30 provided with the container sealing structure is formed of the metal material, the sealing structure can be formed by applying the deep drawing, the ironing or the like by selecting the metal material which exhibits the excellent formability whereby it is possible to provide the container which exhibits the excellent durability and the excellent leaking resistant against impacts.

(2) When the whole container 30 is formed of the plastic material, the container 30 can be formed using techniques such as injection molding, extrusion molding and the like and hence, the manufacturing cost for manufacturing the container sealing structure on a mass production basis can be reduced.

(3) The whole container 30 can be sealed by mounting the bottom lid portion 35 to the lower portion of the container body and hence, it is possible to fill a beverage or the like in a state that pouring portion is arranged downward and, thereafter, the sealing step can be easily performed whereby the container is suitable for application to beverage cans.

(4) Portions of the easily breakable portions 34, 37 can be easily unsealed and, at the same time, when some beverage remains in the container, it is possible to preserve the beverage by resealing the container 30 using the cap portion 33, 38 thus exhibiting the excellent handling property.

(5) Since the easily breakable portions 34, 37 are formed in the thin-wall groove shape or in the slit shape, at the time of unsealing the container 30, these portions 34, 37 are broken and a user perceives a peculiar sound or a hand feeling so that the user can clearly judge that the container is initially unsealed. Once the container is unsealed, it is impossible to repair the broken portion again and hence, the tamper evident characteristics can be ensured.

Here, in the above-mentioned embodiments 1 to 5, some portions thereof are explained by illustrating the case in which the position of the easily breakable portion is disposed at the lower portion of the outer wall, such a position is not limited in the present invention and it is possible to provide the easily breakable portion at other position such as any location between the lower portion and the upper portion of the intermediate wall, for example.

### INDUSTRIAL APPLICABILITY

According to the container sealing structure described in claim 1, it is possible to provide the container sealing structure which can exhibit the excellent productivity of manufacturing the containers and the excellent durability during transportation. Further, even the infant, the aged person or the like can easily unseal the container using the easily breakable portion.

According to the container sealing structure described in claim 2, it is possible to enhance the resiliency in the direction to enlarge or shrink the end portion side of the intermediate wall formed of the metal material such as aluminum, steel or the like, for example, and hence, after unsealing the container by separating the easily breakable portion, it is possible to surely mount the cap portion to the intermediate wall of the pouring portion.

According to the container sealing structure described in claim 3, it is possible to hygienically preserve the beverage which remains in the inside of the container after opening the container from which the easily breakable portion is separated.

According to the container sealing structure described in claim 4, the resealing can be performed by merely screwing the cap portion thus exhibiting the excellent handling property.

According to the container sealing structure described in claim 5, when the cap portion is twisted, upper and lower portions of the torsional resilient panel are deformed in a compressed manner thus giving rise to a thread thrust by a torsional torque. The tensile strength generated by the thread thrust is added to the shearing force thus facilitating the breaking of the easily breakable portion whereby the unsealing becomes easy.

According to the container sealing structure described in claim 6, the resealing can be performed by one touch manipulation which merely pushes the cap portion and hence, even the infant, the aged person or the like can easily handle the container sealing structure.

According to the container sealing structure described in claim 7, by breaking the easily breakable portion thus separating the cap portion from the container body, it is possible to pour out the contents from the container and, at the same time, the separated cap portion can be utilized again for the purpose of resealing.

According to the container sealing structure described in claim 8, the easily breakable portion is formed of scores. Due to such a constitution, it is possible to surely and easily form the easily breakable portion.

According to the container sealing structure described in claim 9, the unsealing property can be enhanced.

According to the container sealing structure described in claim 10, the sealing property at the time of resealing can be enhanced. The container sealing structure is particularly effective in the engagement adopting the undercut structure.

According to the container sealing structure described in claim 11, the metal material which exhibits the excellent formability can be applied and hence, the fold-back operation for forming the triplicate wall consisting of the inner wall, the intermediate wall and the outer wall is facilitated whereby it is possible to provide the container sealing structure which exhibits the excellent durability and the excellent anti-leaking property.

According to the container sealing structure described in claim 12, due to the constitution of the container sealing structure, it is possible to apply a molding method such as injection molding, extrusion molding or the like thus enabling the reduction of a manufacturing cost at the time of manufacturing the container sealing structures on a mass production basis.

According to the container described in claim 13, filling and sealing of the contents can be performed from the lower portion of the container body and the can lid of the conventional mode can be used and hence, it is possible to make use of the most of the existing filling facility.

According to the manufacturing method of the container sealing structure described in claim 14, it is possible to manufacture the sealing structure corresponding to the embodiment 1 or 6 using the existing facility.

According to the manufacturing method of the container sealing structure described in claim 15, it is possible to manufacture the sealing structure corresponding to the embodiment 1 or 3 more easily using the existing facility.

According to the manufacturing method of the container sealing structure described in claim 16, it is possible to manufacture the sealing structure corresponding to the embodiment 1 or 5 in a more stable manner using the existing facility.

According to the manufacturing method of the container sealing structure described in claim 17, it is possible to manufacture the sealing structure corresponding to the embodiment 1 or 5 using the existing facility.

According to the manufacturing method of the container sealing structure described in claim 18, it is possible to manufacture the sealing structure corresponding to the embodiment 2 or 3 more simply using the existing facility.

According to the manufacturing method of the container sealing structure described in claim 19, it is possible to manufacture the sealing structure corresponding to the embodiment 5 using the existing facility.

1. A container sealing structure being comprising: a pouring portion and a cap portion are continuously and integrally formed, an easily breakable portion is provided, and the pouring portion and the cap portion are constituted of an intermediate wall which is folded back downwardly from an upper end portion of an inner wall and an outer wall which is folded back upwardly from a lower end portion of the intermediate wall.

2. (canceled)

3. A container sealing structure according to claim 1, wherein the container sealing structure includes engaging portions.

4. A container sealing structure according to claim 3, wherein the engaging portions are formed of threads.

5. A container sealing structure according to claim 4, wherein in a midst portion of a contiguous path which connects threads formed on the cap portion and threads which are engaged with the threads formed on the cap, a panel shape which becomes resilient by a torsional force is formed.

6. A container sealing structure according to claim 3, wherein the engaging portions are formed of the undercut structure.

7. A container sealing structure according to claim 1, wherein the easily breakable portion is formed on a boundary between the pouring portion and the cap portion.

8. A container sealing structure according to claim 1, wherein the easily breakable portion is formed of scores.

9. A container sealing structure according to claim 1, wherein the easily breakable portion is formed of slits.

10. A container sealing structure according to claim 1, wherein a sealing material is interposed between an inner surface of the cap portion and the pouring portion.

11. A container sealing structure according to claim 1, wherein the container sealing structure is formed of a metal material.

12. A container sealing structure according to claim 1, wherein the container sealing structure is formed of a plastic material.

13. A container being characterized in that the container includes the container sealing structure described in claim 1.

14. A manufacturing method of a container sealing structure comprising the steps of:
integrally forming a cylindrical portion which is substantially coaxial and makes one portion thereof have a diameter different from diameters of other portions;
forming a triplicate wall consisting of an inner wall, an intermediate wall and an outer wall in which the cylindrical portion is subjected to the fold-back deformation by the compression manipulation of the cylindrical portion in the axial direction such that the portion of the cylindrical portion having a small diameter is arranged inside the portion of the cylindrical portion having a large diameter; and
forming an easily breakable portion on the cylindrical portion.

15. A manufacturing method of a container sealing structure according to claim 14, wherein the portion of the cylindrical portion having the large diameter is formed by a diameter expanding manipulation or the portion of the cylindrical portion having the small diameter is formed by a diameter narrowing manipulation.

16. A manufacturing method of a container sealing structure according to claim 14, wherein the portion which is folded back by the axial compression manipulation of the cylindrical portion is preliminarily formed with a thickness smaller than thicknesses of other portions.

17. A manufacturing method of a container sealing structure according to claim 14, wherein one of thread engaging portions and fitting engaging portions are formed on the cylindrical portion by applying thread forming or undercut forming to the triplicate wall.

18. A manufacturing method of a container sealing structure according to claim 14, wherein one of threads and undercut shapes are applied to a portion which is expected to become a cap and a portion which is expected to become a pouring portion preliminarily, triplicate wall are formed by generating the deformation which folds back a cylindrical portion, and one of the threads and the undercut shapes are engaged with each other respectively.

19. A manufacturing method of a container sealing structure according to claim 17, wherein the method further comprises the step of a panel shape which becomes resilient by a torsional force forming in a midst portion of a path which continuously connects a portion where threads are formed and a portion where threads with which the threads are formed at a portion which is expected to become the cap portion.
